(19) United States
(12) Patent Application Publication
(10) Pub. No.: US 2022/0337719 A1
(43) Pub. Date: Oct. 20, 2022

(54) RESTORE OF APPLICATION AFTER DEVICE RESET

(71) Applicant: HEWLETT-PACKARD DEVELOPMENT COMPANY, L.P., Spring, TX (US)

(72) Inventors: Junghun KIM, Seongnam-si, Gyeonggi-do (KR); Sejong KIM, Seongnam-si, Gyeonggi-do (KR); Sangmi KIM, Seongnam-si, Gyeonggi-do (KR); Jinkyu KOOK, Seongnam-si, Gyeonggi-do (KR); Min NAMGOONG, Seongnam-si, Gyeonggi-do (KR); Hyunwoo YOO, Seongnam-si, Gyeonggi-do (KR); Byeongju HWANG, Seongnam-si, Gyeonggi-do (KR); Minyoung SON, Seongnam-si, Gyeonggi-do (KR)

(21) Appl. No.: 17/641,232

(22) PCT Filed: Jun. 30, 2020
(86) PCT No.: PCT/US2020/040224

§ 371 Date: Mar. 8, 2022

(30) Foreign Application Priority Data
Jan. 6, 2020 (KR) 10-2020-0001202

(51) Int. Cl. H04N 1/00; G06F 8/61; G06F 21/10

(52) U.S. Cl. CPC H04N 1/00938; H04N 1/00973; H04N 1/00244; H04N 1/00954; G06F 8/61; G06F 21/105; G06F 2221/0773

(57) ABSTRACT

In order to recover an image forming apparatus, an example computing device determines a target application to be installed in the image forming apparatus based on an application history of the image forming apparatus and obtains configuration information of the target application. The computing device creates a first task of installing the target application in the image forming apparatus and a second task of configuring the target application installed in the image forming apparatus based on the configuration information, and transfers the first task and the second task to the image forming apparatus.

### BACKGROUND

When a device such as a printer registers with a cloud server called a command center, the cloud server manages histories of applications installed on the device, or licenses granted to the device.

### BRIEF DESCRIPTION OF THE DRAWINGS

Various examples will be described below by referring to the following figures.

FIG. 1 is a diagram showing a network-based device management system according to an example.

FIG. 2 is a diagram showing a method of recovering a device according to an example.

FIG. 3 is a diagram showing a method of determining a recovery of a device according to an example.

FIG. 4 is a diagram showing a method of recovering a license according to an example.

FIG. 5 is a diagram showing a method of recovering an application according to an example.

FIG. 6 is a diagram showing a method of recovering an application configuration according to an example.

FIG. 7 and FIG. 8 are diagrams showing a method of determining a recovery of a device according to examples.

FIG. 9 is a diagram showing a method of recovering a license according to an example.

FIG. 10 is a diagram showing a method of recovering an application according to an example.

FIG. 11 is a diagram showing a method of resetting a device according to an example.

FIG. 12 is a diagram showing a computing device according to an example.

### DETAILED DESCRIPTION

As those skilled in the art will realize, the following described examples may be modified in various different ways, all without departing from the spirit or scope of the present invention. In order to clarify the present disclosure, parts that are not relevant to the description will be omitted, and the same elements or equivalents are referred to by the same reference numerals throughout the specification.

As used herein, when a part is described to “include” or “comprise” a certain element, it means that the part may further include or comprise other elements rather than exclude other elements, unless specifically indicated otherwise.

The term “transmit”, “transfer”, “provide”, “receive”, or “acquire” may be used to include not only direct transmission, transfer, provision, reception, or acquisition but also indirect transmission, transfer, provision, reception, or acquisition through another device or using a bypass.

The singular forms “a”, “an”, and “the” may be intended to include the plural forms as well, unless an explicit expression such as “one” or “singular” is used.

The expression “and/or” may include each of the referred elements and every combination of one or more thereof.

Although the terms first, second, and the like may be used herein to describe various elements, components, steps, and/or operations, these terms may simply be used to distinguish one element, component, step, or operation from another element, component, step, or operation. Thus, a first element component, step, or operation discussed below could be termed a second element, component, step, or operation.

In a flowchart described with reference to the accompanying drawings, an operation order may be changed, several operations may be merged, a certain operation may be divided, and a specific operation may be omitted.

An application may refer to a program that is installed and executed on a device and is designed to achieve a specific purpose or to implement a specific function. For example, the application may be a file sharing application, a document print application, a document scan application, and the like. The application may include a solution program that addresses a software or hardware issue of the device.

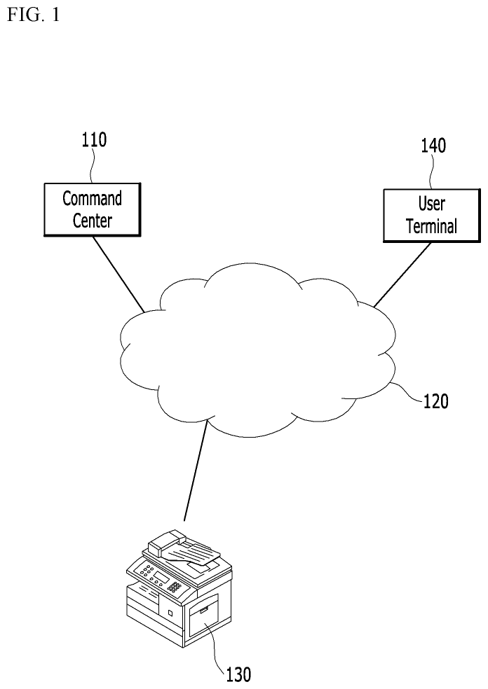

FIG. 1 is a diagram showing a network-based device management system according to an example.

Referring to FIG. 1, a command center 110 may be connected to a device 130 and a user terminal 140 through a network 120.

The command center 110 and the user terminal 140 may be implemented as computing devices. In an example, the command center 110 may be implemented as a cloud-based server.

The device 130 may be an image forming apparatus that generates, prints, receives, or transmits image data. In various examples, the image forming apparatus may be a printer, a scanner, a copier, a fax machine, or a multifunction printer incorporating these functions. The device 130 may include a memory and a processor. The device 130 may be registered with the command center 110 through onboarding.

The command center 110 may communicate with the device 130 to manage installation, deletion, or configuration of an application in the device 130, and may also manage a license of a paid application in the device 130. In an example, the command center 110 may detect a change such as a reset of the device 130 and automatically restore an application installed in the device 130 and the application's configuration. In an example, the command center 110 may detect a change such as a reset of the device 130 and automatically restore a license purchased by the device 130.

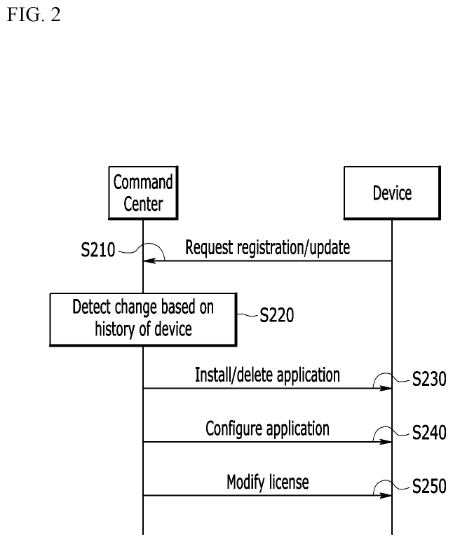

The user terminal 140 may be a terminal used by a user. The user may be, for example, a reseller of the device 130, an administrator of a client company (for example, a company that has purchased the device 130), a general user of the client company, etc. In an example, some operations of the command center 110 to be described with reference to FIG. 2 to FIG. 11 may be performed in response to an operation from the user terminal 140.

There may be a case in which a reset such as a factory clear, a firmware update, etc. is forcibly performed on the device 130. In that case, a license mismatch or an application mismatch problem may occur between the device 130 and the command center 110 with which the device 130 is registered.

A method of recovering a device according to various examples is described with reference to FIG. 2 to FIG. 6.

FIG. 2 is a diagram showing a method of recovering a device according to an example.

Referring to FIG. 2, a device may request a registration or an update to a command center at operation S210. In an example, the device may be in a reset state in which a reset is manually performed on the device without input from the command center. In an example, the device may be in a reset state in which a factory clear or a firmware update is performed on the device. In an example, the device may perform an onboarding procedure to register with the command center. In an example, the device may request the command center to update device information.

The command center may detect a change of the device by checking a history of the device managed by the command center at operation S220. Upon detecting the change of the device, the command center may perform a recovery procedure of the device based on the history of the device at operations S230, S240, and S250.

The command center may modify an application in the device based on the history of the device at operation S230. In an example, the command center may modify the application in the device by installing an application in the device based on the history of the device. In another example, the command center may modify the application in the device by deleting the application from the device based on the history of the device.

The command center may configure an application installed in the device based on the history of the device at operation S240. In an example, when installing the application in the device, the command center may configure the installed application based on the history of the device. In another example, when a configuration of the application installed in the device is changed, the command center may modify the configuration of the application based on the history of the device.

The command center may modify a license of an application installed in the device based on the history of the device at operation S250. In an example, when installing the application in the device, the command center may set the license of the installed application based on the history of the device.

According to the above-described examples, the application and license that are originally installed may be automatically recovered based on the history of the device. Accordingly, the device can be prevented from not operating normally due to desynchronization with the command center.

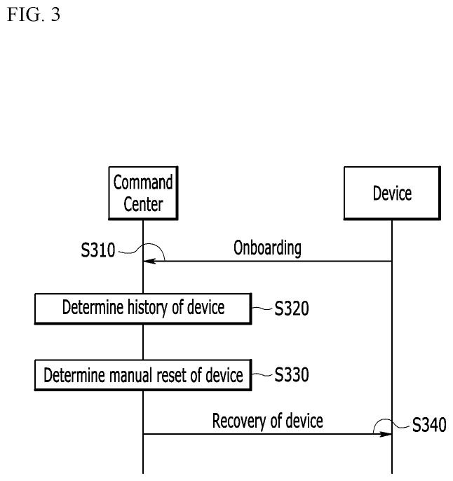

Examples of recovering an onboarding device are described with reference to FIG. 3 to FIG. 6.

FIG. 3 is a diagram showing a method of determining a recovery of a device according to an example.

Referring to FIG. 3, a device may perform an onboarding procedure to register with a command center at operation S310. In an example, the device may be in a reset state in which a reset is manually performed on the device without input from the command center. In an example, the device may be in a reset state in which a factory clear or a firmware update is performed on the device.

The command center may determine whether there is a history of the device requesting onboarding at operation S320. In an example, the history of the device may include information indicating a status of the device (e.g., a serial number of the device, a firmware version, etc.), information indicating a connection date of the device, or information indicating an application status of the device (e.g., an installed application). In an example, the history of the device may include a task history. In an example, the task history may include a history associated with a task of an application (hereinafter referred to as an “application history”) or a history related to a license (hereinafter referred to as a “license history”). The application history may include, for example, a history related to an installation or deletion of the application. The license history may include, for example, a history related to granting or releasing the license.

If the history of the device exists, the command center may determine that a status of the device has been changed at operation S330. In an example, the command center may determine that the status of the device has been changed by being manually reset. The command center may perform a recovery procedure of the device based on the history of the device at operation S340.

According to the above-described examples, the device may be automatically recovered by automatically determining that the device has changed based on the history of the device.

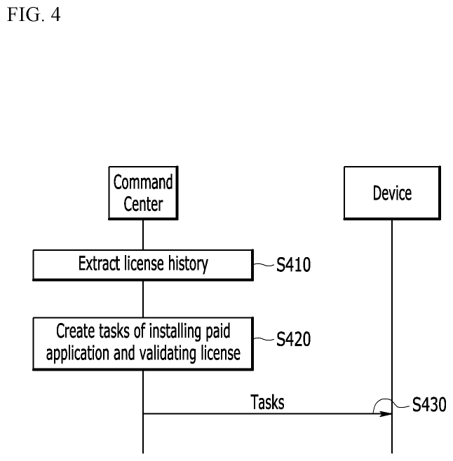

FIG. 4 is a diagram showing a method of recovering a license according to an example.

Referring to FIG. 4, in order to recover a device attempting onboarding, a command center may extract a license history of the device based on a history of the device at operation S410. The command center may create a task set including a task of installing a paid application and validating its license based on a license history at operation S420. In an example, for compatibility, the command center may determine a version of a previously-installed application based on the history of the device and create a task of installing the application with the corresponding version. In an example, the command center may create a task of installing an application with the latest version instead of the previously-installed version. In an example, when the version of the previously-installed application is not available, the command center may create a task of installing the application with the latest version.

In an example, when there are a plurality of paid applications to be installed, the command center may determine an execution order of tasks of installing the plurality of applications and create a task set of executing the tasks in the execution order. In an example, the command center may determine an order in which the plurality of applications are installed based on the history of the device and create the task set of allowing the plurality of applications to be installed in the determined order. The task set may be created to perform the tasks of installing the plurality of applications in the installation order.

The command center may transfer the task set to the device at operation S430 so that the paid application can be installed in the device and the license can be valid according to the tasks included in the task set.

According to the above-described examples, since the paid application is reinstalled based on the license history, the license can be managed based on the license history so that a fee for the license is not additionally charged.

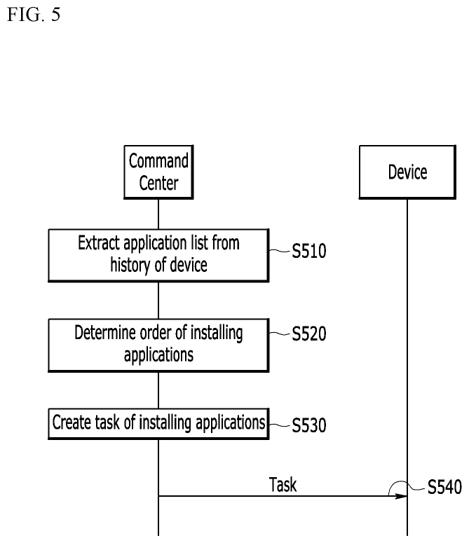

FIG. 5 is a diagram showing a method of recovering an application according to an example.

Referring to FIG. 5, in order to recover a device attempting onboarding, a command center may extract a list of applications stored as a history of the device at operation S510. In an example, the list of applications may include a list of free applications. In an example, the command center may extract the application list of a final state from the history of the device. In an example, the command center may extract the application list based on a state machine.

The command center may create a task set including a task of installing each application based on the application list at operation S530. In an example, the command center may determine a version of a previously-installed application based on a history of the device and create a task of installing the application with the corresponding version. In an example, the command center may create a task of installing an application with the latest version instead of the previously-installed version. In an example, when the version of the previously-installed application is not available, the command center may create a task of installing the application with the latest version.

In an example, the command center may determine an execution order of tasks of installing a plurality of applications at operation S520 and create a task set of executing the tasks in the execution order at operation S530. In an example, the command center may determine an order in which the plurality of applications are installed based on the history of the device and create the task set of allowing the plurality of applications to be installed in the determined order. The task set may be created to perform the tasks of installing the plurality of applications in the installation order.

The command center may transfer the task set to the device at operation S540 so that the applications can be installed on the device according to the tasks included in the task set.

In an example, a task set that includes a task of installing a free application may be created separately from a task set that includes a task of installing a licensed paid application. In an example, the task of installing the free application and the task of installing the paid application may be included in the same task set. In an example, when the task of installing the free application and the task of installing the paid application are included in the same task set, the task set may be created so that the paid application can be first installed.

According to the above-described examples, the originally-installed application can be automatically recovered based on the history of the device. Accordingly, the device can be prevented from not operating normally due to desynchronization with the command center.

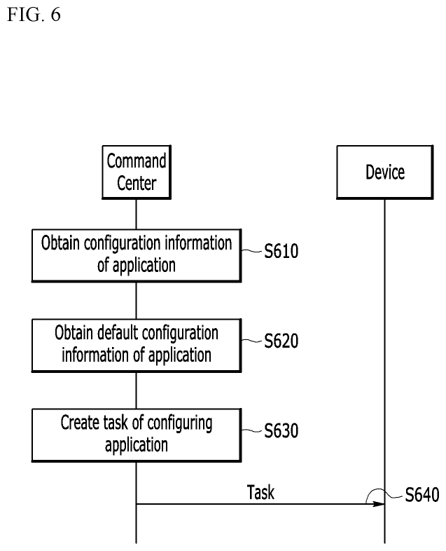

FIG. 6 is a diagram showing a method of recovering an application configuration according to an example.

Referring to FIG. 6, in order to recover a device attempting onboarding, after installing applications in the device, a command center may obtain configuration information of each application set for the device from a database at operation S610. In an example, the configuration information may include configuration values of configuration items for the application. For example, when the application is an application for printing, various configuration items such as an item for paper selection, an item for the number of copies, an item for collate, etc. may be provided for configuration of the application, and the configuration information may include a configuration value of each configuration item. In an example, the database that stores the configuration information may be implemented in a server provided separately from the command center. In an example, the database may be implemented within the command center.

If there is an application whose configuration information is not stored in the database, the command center may obtain default configuration information of the corresponding application from an application center at operation S620. In an example, the default configuration information may include configuration values (default configuration values) that are applied by default when the application is installed. For example, the default configuration values may include configuration values related to a type or a size of paper, configuration values related to a print resolution, etc. In an example, the application center may store a new application or an updated application and may store a file including default configuration information of the application. In an example, the command center and the application center may be provided as separate servers. In an example, the command center and the application center may be provided in the same server.

The command center may create a task set including a task of configuring an application installed in the device based on the configuration information or default configuration information of the application at operation S630. The command center may transfer the task set to the device at operation S640 so that the application installed in the device can be configured according to the task included in the task set.

In an example, a task set that includes the task of configuring the application may be created separately from a task set that includes the task of installing the application. In an example, the task of installing the application and the task of setting the application may be included in the same task set. In an example, when a user selects an application, the command center may create a task of configuring the selected application.

According to the above-described examples, the configuration of the application may be automatically recovered based on the history of the device. Accordingly, the device can be prevented from not operating normally due to desynchronization with the command center.

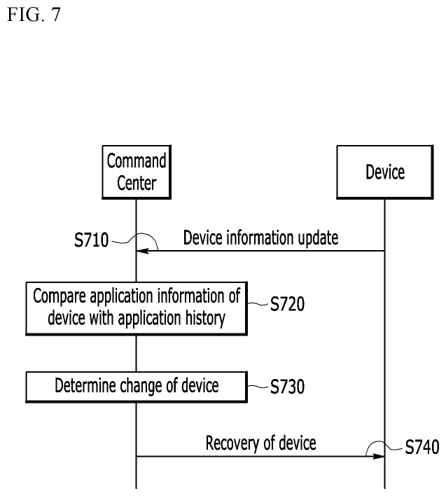

Examples of recovering a device attempting to update device information are described with reference to FIG. 7 to FIG. 10.

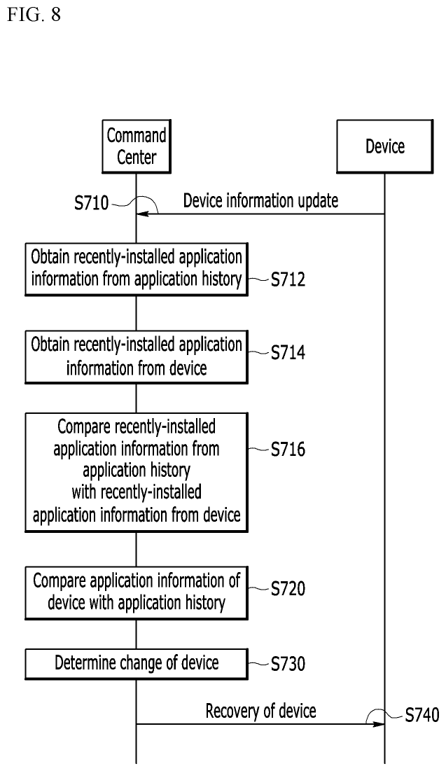

FIG. 7 is a diagram showing a method of determining a recovery of a device according to an example, and FIG. 8 a diagram showing a method of determining a recovery of a device according to another example.

Referring to FIG. 7, a device may perform a device information update procedure at operation S710. In an example, the device may be in a reset state in which a reset is manually performed on the device without input from the command center. In an example, the device may be in a reset state in which a factory clear or a firmware update is performed on the device. In an example, the device may be in a state in which some applications may be installed or deleted without input from the command center.

The command center may determine whether the device has been changed by comparing current information of the device requesting the device information update with the history of the device managed by the command center. In an example, the history of the device may include a task history. In an example, the task history may include an application history or a license history. The application history may include, for example, a history related to an installation or deletion of the application. The license history may include, for example, a history related to granting or releasing of the license.

In an example, the command center may compare the information of the application installed in the device with the application history managed by the command center at operation S720. When there is a difference in the installed application as a result of the comparison, the command center may determine that the recovery is necessary according to the change of the device at operation S730.

In an example, referring to FIG. 8, the command center may obtain information of a recently-installed application based on the application history at operation S712, and may obtain information of a recently-installed application from the device at operation S714. The command center may compare the information of the recently-installed application based on the application history with the information of the recently-installed application from the device at operation S716. When one information is the same as the other information, the command center may determine that the information of the device has been updated. If one information is different from the other information, the command center may compare an installation history of all applications obtained from the application history with the information of the applications installed in the device at operation S720. When there is a difference in the installed applications as a result of the comparison, the command center may determine that the recovery is necessary according to the change of the device at operation S730. As such, the load according to the comparison can be reduced, by comparing the recently-installed applications first.

In an example, the information of the application may include identification information (e.g., an identifier) of the application. In an example, the information of the application may include identification information of the application and version information of the application.

The command center may perform a recovery procedure of the device based on the changed status at operation S740.

According to the above-described examples, the device may be automatically recovered by automatically determining that the device has changed based on the history of the device.

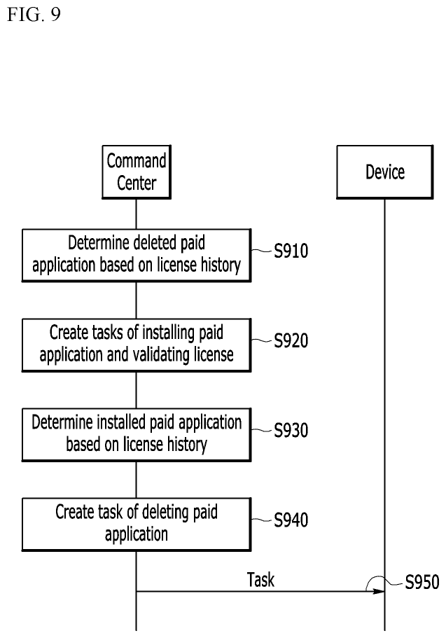

FIG. 9 is a diagram showing a method of recovering a license according to an example.

Referring to FIG. 9, when a device is changed by a change in a license of a device, a command center may determine whether a paid application has been deleted at operation S910 and whether a paid application has been installed at operation S930, based on a license history of the device.

In a case in which the paid application licensed through the command center has been deleted at operation S910, the command center may create a task set including a task of installing the paid application and validating the license at operation S920. In an example, the command center may determine a version of a previously-installed paid application based on a history of the device and create a task of installing the paid application with the corresponding version. In an example, the command center may create a task of installing the paid application with the latest version instead of the previously-installed version. In an example, when the version of the previously-installed paid application is not available, the command center may create a task of installing the paid application with the latest version.

In an example, when there are a plurality of paid applications to be installed, the command center may determine an execution order of tasks of installing the plurality of paid applications and create a task set of executing the tasks in the execution order. In an example, the command center may determine an order in which the plurality of paid applications are installed based on the history of the device and create the task set of allowing the plurality of paid applications to be installed in the determined order. The task set may be created to perform the tasks of installing the plurality of paid applications in the installation order.

When a paid application whose license is not granted through the command center has been installed at operation S930, the command center may create a task set including a task of deleting the paid application at operation S940.

The command center may transfer the task set to the device at operation S950, so that the paid application can be installed on the device and its license can be validated, or the unlicensed paid application can be deleted, according to the tasks included in the task set.

According to the above-described examples, since the paid application is reinstalled based on the license history, the license can be managed based on the license history so that a fee for the license is not additionally charged. Further, the paid application installed without the license can be deleted.

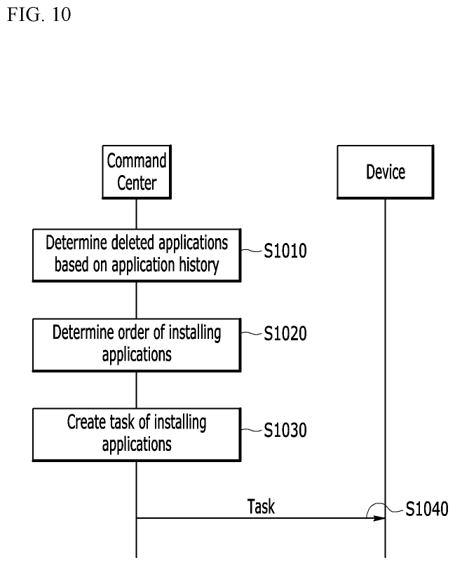

FIG. 10 is a diagram showing a method of recovering an application according to an example.

Referring to FIG. 10, a command center may determine a free application which has been deleted from a device, based on an application history and information of applications installed in the device, at operation S1010, and may create a task set including a task of installing the deleted application at operation S1020. In an example, the command center may determine a version of a previously-installed application based on a history of the device and create a task of installing an application with the corresponding version. In an example, the command center may create a task of installing an application with the latest version instead of the previously-installed version. In an example, when the version of the previously-installed application is not available, the command center may create a task of installing the application with the latest version.

In an example, the command center may determine an execution order of tasks of installing a plurality of applications at operation S1020 and create a task set of executing the tasks in the execution order at operation S1030. In an example, the command center may determine an order in which the plurality of applications are installed based on the history of the device and create the task set of allowing the plurality of applications to be installed in the determined order. The task set may be created to perform the tasks of installing the plurality of applications in the installation order.

The command center may transfer the task set to the device at operation S1040 so that an application can be installed in the device according to the tasks included in the task set.

In an example, a task set that includes a task of installing a free application may be created separately from a task set that includes a task of installing a licensed paid application. In an example, the task of installing the free application and the task of installing the paid application may be included in the same task set. In an example, when the task of installing the free application and the task of installing the paid application are included in the same task set, the task set may be created so that the paid application can be first installed.

In an example, the command center may create a task set including a task of deleting an additionally-installed free application, based on an installation history of applications and status information of applications installed in the device.

In an example, after installing the application in the device, the command center may configure the application, similar to the various examples described above.

According to the above-described examples, the originally-installed application can be automatically recovered based on the history of the device. Accordingly, the device can be prevented from not operating normally due to desynchronization with the command center.

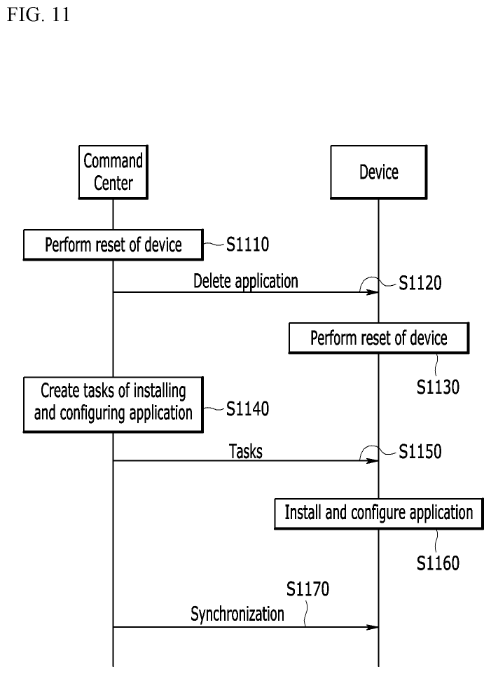

An example of resetting a device is described with reference to FIG. 11.

FIG. 11 is a diagram showing a method of resetting a device according to an example.

Referring to FIG. 11, a command center may perform a reset of a device at operation S1110. In an example, the command center may perform the reset such as a factory clear or a firmware update. In response to the reset, the command center may delete an application installed in the device at operation S1120. In an example, the command center may extract a list of applications installed in the device based on a history of the device, create a task set including a task of deleting the applications, and transfer the task set to the device.

The device may perform a reset on the device at operation S1130. In an example, the device may perform the reset such as a factory clear or a firmware update.

The command center may create a task of installing an application that was installed in the device prior to the reset and a task of configuring the corresponding application based on the history of the device at operation S1140. The command center may transfer a task set including the tasks to the device in operation S1150 and the device may install and configure the application at operation S1160. The device may request a device information update from the command center to synchronize with the command center at operation S1170.

According to the above-described examples, the device can be reset while maintaining synchronization with the command center.

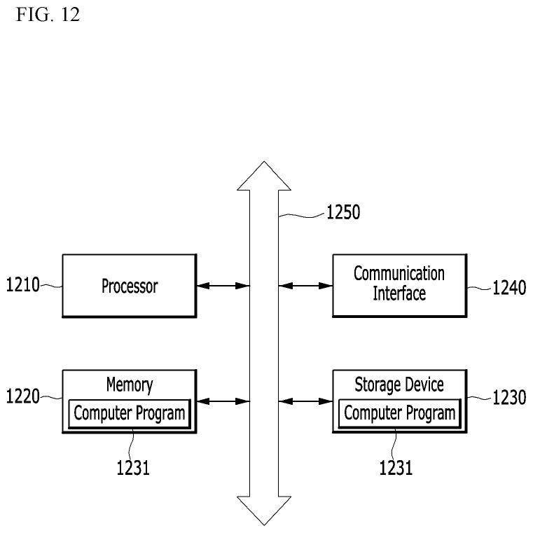

In an example, a command center, a method of recovering a device, a method of determining a recovery of a device, a method of recovering a license, a method of recovering an application, a method of recovering an application configuration, or a method of resetting a device may be implemented by a computing device having computing functions. An example computing device is described with reference to FIG. 12. Although FIG. 12 shows an example implemented with one computing device, the above-described device or method may be implemented by a plurality of computing devices.

FIG. 12 is a diagram showing a computing device according to an example.

Referring to FIG. 12, a computing device includes a processor 1210, a memory 1220, a storage device 1230, a communication interface 1240, and a bus 1250. The computing device may further include other general components.

The processor 1210 may control an operation of each component of the computing device. The processor 1210 may be implemented with processing circuitry. For example, the processing circuitry may include a central processing unit (CPU), an application processor (AP), a microprocessor unit (MPU), a micro controller unit (MCU), an arithmetic logic unit (ALU), a graphic processing unit (GPU), a digital signal processor, a field programmable gate array (FPGA), a system on chip (SoC), a programmable logic unit, or an application-specific integrated circuit (ASIC). In addition, the processor 1210 may perform operations on a program for executing the above-described method.

The memory 1220 may store various data, commands, and/or information. The memory 1220 may load a computer program 1231 from the storage device 1230 to execute the above-described method. The storage device 1230 may non-temporarily store the computer program 1231. The storage device 1230 may be implemented as a non-volatile memory.

The communication interface 1240 may support wired or wireless Internet communication of the computing device. The communication interface 1240 may support various communication methods other than the Internet communication.

The bus 1250 may provide a communication function between components of the computing device. The bus 1250 may be implemented as various types of buses such as an address bus, a data bus, a control bus, and the like.

The computer program 1231 may include instructions that cause processor 1210 to perform the above-described method when loaded into memory 1220. That is, the processor 1210 may perform operations for the above-described method by executing the instructions.

In an example, a command center, a method of recovering a device, a method of determining a recovery of a device, a method of recovering a license, a method of recovering an application, a method of recovering an application configuration, or a method of resetting a device may be implemented as a computer-readable program on a non-transitory computer-readable medium. In an example, the non-transitory computer-readable medium may include, for example, a removable recording medium or a fixed recording medium. In an example, the computer-readable program recorded on the non-transitory computer-readable medium may be transmitted to another computing device via a network such as the Internet and installed in another computing device, so that the computer program can be executed by another computing device.

Although various examples have been described in above, the scope is not limited thereto, and various modifications and improvements by those skilled in the art using the basic concepts defined in the following claims also fall within the scope of rights.

What is claimed is:

1. A computing device comprising:
a communication interface to be connected with an image forming apparatus via a network;
a memory; and
a processor, by executing instructions of a program loaded in the memory, to:
determine a target application to be installed in the image forming apparatus based on an application history of the image forming apparatus;
obtain configuration information of the target application;
create a first task of installing the target application in the image forming apparatus and a second task of configuring the target application installed in the image forming apparatus based on the configuration information; and
transfer the first task and the second task to the image forming apparatus.

2. The computing device of claim 1,
wherein the target application includes a paid application, and
wherein the processor is further to validate a license of the paid application installed in the image forming apparatus based on a license history of the image forming apparatus.

3. The computing device of claim 2,
wherein the target application further includes a free application, and
wherein the processor is further to create the first task of allowing the paid application to be installed in the image forming apparatus earlier than the free application.

4. The computing device of claim 2, wherein the processor is further to:
when determining that a paid application whose license is not granted to the image forming apparatus is installed in the image forming apparatus based on the license history of the image forming apparatus, create a third task of deleting the paid application from the image forming apparatus; and
transfer the third task to the image forming apparatus.

5. The computing device of claim 1,
wherein the target application includes a plurality of applications, and
wherein the processor is further to:
determine an installation order of the plurality of applications based on the application history; and
create the first task of allowing the plurality of applications to be installed in the image forming apparatus in the installation order.

6. The computing device of claim 1, wherein the processor is further to:
determine a version of the target application previously installed in the image forming apparatus based on the application history; and
create the first task of installing the target application with the previously-installed version when the target application of the previously-installed version is available, or create the first task of installing the target application with a latest version when the target application of the previously-installed version is unavailable.

7. The computing device of claim 1, wherein the configuration information, when configuration information stored for the image forming apparatus exists, includes the stored configuration information, or when no configuration information stored for the image forming apparatus exists, includes default configuration information of the target application.

8. The computing device of claim 1,
wherein the image forming apparatus includes an image forming apparatus that attempts to onboard to the computing device after being reset without input from the computing device, and
wherein the processor is further to determine recovery of the image forming apparatus when a history of the image forming apparatus exists, the history of the image forming apparatus including the application history.

9. The computing device of claim 1,
wherein the image forming apparatus includes an image forming apparatus that requests an information update, and
wherein the processor is further to determine a recovery of the image forming apparatus by comparing information of an application installed in the image forming apparatus with the application history.

10. The computing device of claim 9, wherein the processor is further to, when information of a recently installed application obtained from the image forming apparatus is different from information of a recently installed application determined based on the application history, compare the information of the application installed in the image forming apparatus with the application history.

11. A non-transitory computer readable medium comprising:
instructions to determine whether a history of an image forming apparatus attempting onboarding exists;
instructions to extract an application list stored as the history of the image forming apparatus when the history of the image forming apparatus exists;
instructions to create a first task of installing a target application included in the application list;
instructions to obtain configuration information of the target application based on the history of the image forming apparatus;
instructions to create a second task of configuring the target application based on the configuration information; and
instructions to transfer the first task and the second task to the image forming apparatus.

12. The computer readable medium of claim 11, wherein, when no configuration information of the target application is stored for the image forming apparatus, the configuration information includes default configuration information of the target application.

13. The computer readable medium of claim 11,
wherein the target application includes a paid application, and
wherein the computer readable medium further comprises instructions to validate a license of the paid application installed in the image forming apparatus based on a license history of the image forming apparatus.

14. A non-transitory computer readable medium comprising:
instructions to compare information of an application installed in an image forming apparatus requesting an information update with an application history of the image forming apparatus;
instructions to determine a target application deleted from the image forming apparatus when the information of the application is different from the application history;
instructions to create a first task of installing the target application;
instructions to obtain configuration information of the target application based on a history of the image forming apparatus;
instructions to create a second task of configuring the target application based on the configuration information; and
instructions to transfer the first task and the second task to the image forming apparatus.

15. The computer readable medium of claim 14, further comprising:
instructions to, when determining that a paid application whose license is not granted to the image forming apparatus is installed in the image forming apparatus based on a license history of the image forming apparatus, create a third task of deleting the paid application from the image forming apparatus; and
instructions to transfer the third task to the image forming apparatus.
